(19) United States
(12) Patent Application Publication
(10) Pub. No.: US 2005/0039493 A1
(43) Pub. Date: Feb. 24, 2005

(54) Vapor axial deposition apparatus comprising rod cap

(76) Inventors: Si-Ho Song, Gumi-si (KR); Yeong-Seop Lee, Gumi-si (KR)

Correspondence Address: CHA & REITER, LLC, 210 ROUTE 4 EAST STE 103, PARAMUS, NJ, 07652, US

(21) Appl. No.: 10/897,956

(22) Filed: Jul. 23, 2004

(30) Foreign Application Priority Data
Aug. 21, 2003 (KR) 2003-57962

(51) Int. Cl. C03B 37/018

(52) U.S. Cl. 65/531

(57) ABSTRACT

A vapor axial deposition apparatus for creating an optical fiber perform includes a starting rod axially fixed at one end to a chuck that rotates and moves vertically. A rod cap fixed to the other end of the starting rod is a rotary body with a downwardly facing end portion in axial alignment with the starting rod, and can be configured it various shapes. One heater underneath the rod cap, which receives fuel and raw material, shoots flames up at the rod cap to create a core while another heater, similarly supplied, laterally shoots flames at an outer circumference of the rod cap to create a cladding. A deposited core/cladding ratio is adjusted according to shapes of the rod cap, and finely adjusted by controlling fuel and raw material, the distance between the heaters and the angling of the heaters.

### CLAIM OF PRIORITY

This application claims priority to an application entitled “VAPOR AXIAL DEPOSITION APPARATUS COMPRISING ROD CAP,” filed in the Korean Intellectual Property Office on Aug. 21, 2003 and assigned Serial No. 2003-57962, the contents of which are hereby incorporated herein by reference.

### BACKGROUND OF THE INVENTION

1. Field of the Invention

The present invention relates to an apparatus for manufacturing an optical fiber preform, and more particularly to a vapor axial deposition apparatus.

2. Description of the Related Art

An optical fiber preform having an end, from which an optical fiber having a diameter smaller than that of the optical fiber preform is drawn, includes a core and a cladding. Here, the core has a refractive index higher than that of the cladding. Methods for manufacturing the optical fiber preform are mainly divided into outside vapor phase deposition (OVD), vapor axial deposition (VAD), plasma chemical vapor deposition (PCVD), and modified chemical vapor deposition (MCVD). Vapor axial deposition is advantageous in that an optical fiber preform is continuously manufactured in a longitudinal direction by synthesizing glass in an axial direction. Additionally, the vapor axial deposition produces an optical fiber preform having a large diameter and length, thus being suitable for mass-production.

U.S. patent Ser. No. 6,131,415, patented to Kai Huei Chang et al. and entitled “METHOD OF MAKING A FIBER HAVING LOW LOSS AT 1385 nm BY CLADDING A VAD PREFORM WITH A D/d<7.5”, discloses a method for forming a cladding on a core comprising the steps of growing the core on an end of a silica starting rod by shooting a flame toward a central portion of the silica starting rod using a first torch when the silica starting rod rotates, and growing the cladding on the core by shooting a flame toward an outer circumference of the rod using a second torch.

In the above vapor axial deposition method, deposition efficiency of the core and the cladding depends on a surface area of the starting rod.

However, the above conventional vapor axial deposition method is disadvantageous in that the diameter of the starting rod is limitedly increased in order to increase the deposition efficiency of the core, and an additional step for increasing the deposition efficiency of the cladding is required. Also, it is difficult to set a deposited cladding/core ratio.

### SUMMARY OF THE INVENTION

The present invention has been made in view of the above problems, and it is an object of the present invention to provide a vapor axial deposition apparatus that remarkably improves deposition efficiency for a core and cladding, compared to a conventional apparatus.

In accordance with the present invention, the above and other objects can be accomplished by the provision of a vapor axial deposition apparatus for manufacturing an optical fiber preform, comprising: a chuck moving vertically and rotating; a starting rod having an upper end fixed to the chuck; a rod cap fixed to a lower portion of the starting rod and serving as a rotary body having a narrowed end; a first heater for growing a core on a central portion of the rod cap by shooting a flame toward the central portion; and a second heater for growing a cladding on an outer circumference of the rod cap by shooting a flame toward the outer circumference.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a vapor axial deposition apparatus in accordance with a preferred embodiment of the present invention; and

FIGS. 2a to 2c are schematic views respectively illustrating various shapes of a rod cap of the vapor axial deposition apparatus in accordance with the present invention.

### DETAILED DESCRIPTION OF THE PREFERRED EMBODIMENTS

Preferred embodiments of the present invention will be described in detail with reference to the annexed drawings, detailed description of known functions and configurations incorporated herein being omitted for clarity of presentation.

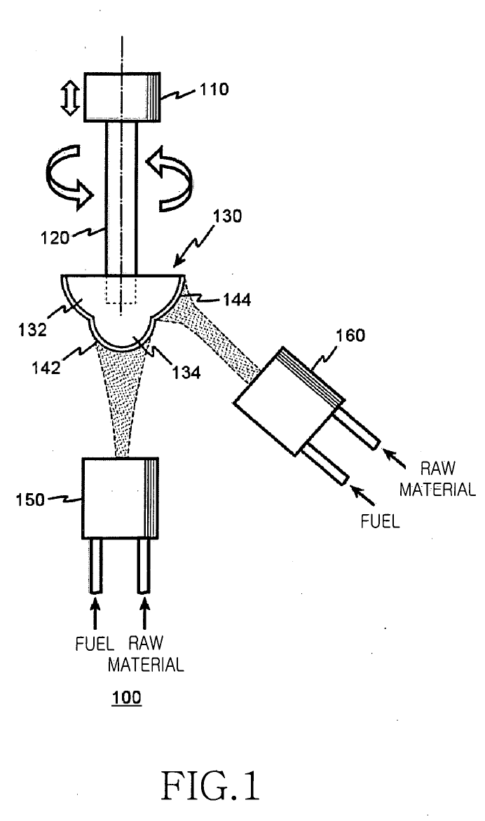

FIG. 1 is a schematic view depicting, by way of illustrative and non-limitative example, a vapor axial deposition apparatus in accordance with a preferred embodiment of the present invention. The apparatus 100 comprises a chuck 110, a starting rod 120, a rod cap 144, and first and second heaters 150, 160.

The chuck 110 can move vertically and rotate, and serves to fix the starting rod 120 by clamping an upper end of the starting rod.

The upper end of the starting rod 120 is fixed to the chuck 110 so that the starting rod rotates and simultaneously moves upward during a vapor axial deposition process.

The rod cap 130 is fixed to a lower portion of the starting rod 120, and has a double-concave shape. The rod cap 130 includes a base portion 132 having a hemispherical shape, and a protruded portion 134 protruding from the base portion and having a hemispherical shape.

The first heater 150 shoots a flame toward a central portion of the rod cap 130, thereby growing a core 142 on the protruded portion 134. The first heater 150 receives fuel and raw material supplied thereto, and then deposits glass material on the protruded portion 134 by shooting the flame thereto.

The second heater 160 shoots a flame toward an outer circumference of the rod cap 130, thereby growing a cladding 144 on the base portion 132. The second heater 160 receives fuel and raw material supplied thereto, and then deposits glass material on the base portion 132 by shooting the flame thereto.

The rod cap 130 is preferably made of quartz or ceramic, and a deposited core/cladding ratio is adjusted according to shapes of the rod cap 130. That is, a diameter ratio of the core 142 to the cladding 144, which are formed on the rod cap 130, is adjusted according to the shapes of the rod cap. The deposited core/cladding ratio is finely adjusted by controlling the fuel and the raw material supplied to the first and second heaters 150, 160 or controlling angles of and an interval between the first and second heaters. Since the surface area of the rod cap 130 is freely adjustable, deposition efficiency can be adjusted accordingly, thereby allowing the deposition process to be easily maintained and productivity to be remarkably increased. Although FIG. 1 illustrates the rod cap 130 having the double concave shape, such is not a limitation of the present invention. The rod cap is a rotary body having a narrowed end, but may have various shapes.

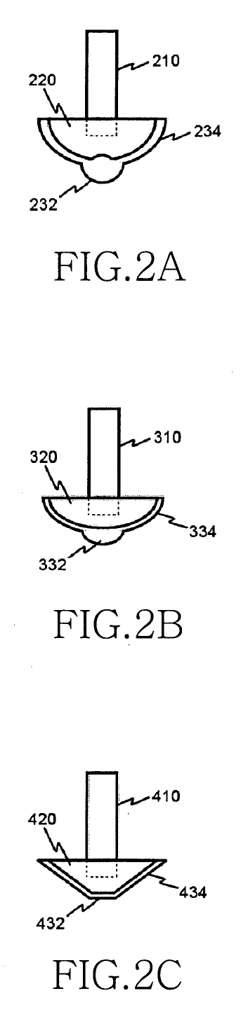

FIGS. 2a to 2c are exemplary schematic views respectively illustrating various shapes of a rod cap of the vapor axial deposition apparatus in accordance with the present invention.

As shown in FIG. 2a, a rod cap 220 fixed to a lower portion of a starting rod 210 has a hemispherical shape, of which a central portion is depressed (other shapes of the rod cap, which will be described later, are hemispherical without a depressed central portion). The core 232 of the optical fiber preform is grown on the central portion of the rod cap 220 by shooting a flame toward the central portion of the rod cap, and a cladding 234 of the optical fiber preform is grown on an outer circumference of the rod cap by shooting a flame toward the outer circumference of the rod cap.

As shown in FIG. 2b, a rod cap 320 fixed to a lower portion of a starting rod 310 has a hemispherical shape. A core 332 of an optical fiber preform is grown on the central portion of the rod cap 320 by shooting a flame toward the central portion of the rod cap, and a cladding 334 of the optical fiber preform is grown on an outer circumference of the rod cap 320 by shooting a flame toward the outer circumference of the rod cap.

As shown in FIG. 2c, a rod cap 420 fixed to a lower potion of a starting rod 410 has a truncated conical shape. A core 432 of an optical fiber preform is grown on the central portion of the rod cap 420 by shooting a flame toward the central portion of the rod cap, and a cladding 434 of the optical fiber preform is grown on an outer circumference of the rod cap by shooting a flame toward the outer circumference of the rod cap.

As apparent from the above description, the present invention provides a vapor axial deposition apparatus for manufacturing an optical fiber preform, which comprises a rod cap, having a designated shape, fixed to a starting rod, affording easy adjustment of a deposited core/cladding ratio of the optical fiber preform.

The vapor axial deposition apparatus for manufacturing the optical fiber preform in accordance with the present invention, which comprises the rod cap having a designated shape and the starting rod to which it is fixed, advantageously allows for easy adjustment of the surface area of the rod cap on which the core and the cladding are deposited, thereby providing efficient control of deposition, easy maintenance of the optical fiber perform manufacturing process, and remarkably increased productivity.

Although preferred embodiments of the present invention have been described in detail, those skilled in the art will appreciate that various modifications, additions, and substitutions to the specific elements are possible, without departing from the scope and spirit of the invention as disclosed in the accompanying claims.

1. A vapor axial deposition apparatus for manufacturing an optical fiber preform, comprising:
a chuck;
a starting rod having a lower portion, and an upper end fixed to the chuck;
a rod cap fixed to said lower portion and serving as a rotary body having a narrowed end;
a first heater for growing a core on a central portion of the rod cap by shooting a flame toward said central portion; and
a second heater for growing a cladding on an outer circumference of the rod cap by shooting a flame toward said outer circumference.

2. The vapor axial deposition apparatus as set forth in claim 1, wherein the rod cap includes a base portion having a hemispherical shape, and a protruded portion protruding from the base portion and having a hemispherical shape.

3. The vapor axial deposition apparatus as set forth in claim 1, wherein the rod cap has a hemispherical shape having a depressed central portion.

4. The vapor axial deposition apparatus as set forth in claim 1, wherein the rod cap has a hemispherical shape.

5. The vapor axial deposition apparatus as set forth in claim 1, wherein the rod cap has a truncated conical shape.

6. The vapor axial deposition apparatus as set forth in claim 1, wherein said narrowed end is disposed toward a portion of said rod cap axially aligned with said starting rod.

7. The vapor axial deposition apparatus as set forth in claim 1, wherein said flame toward said central portion shoots upward and said flame toward said outer circumference shoots laterally.

8. A vapor axial deposition apparatus for manufacturing an optical fiber preform, comprising:
a starting rod configured for axial rotation while positioned vertically, said starting rod having a lower portion;
a rod cap fixed to a lower portion of the starting rod and serving as a rotary body having a narrowed end;
a first heater for growing a core on a central portion of the rod cap by shooting a flame toward said central portion; and
a second heater for growing a cladding on an outer circumference of the rod cap by shooting a flame toward said outer circumference.

9. The vapor axial deposition apparatus as set forth in claim 8, wherein the rod cap includes a base portion having a hemispherical shape, and a protruded portion protruding from the base portion and having a hemispherical shape.

10. The vapor axial deposition apparatus as set forth in claim 8, wherein the rod cap has a hemispherical shape having a depressed central portion.

11. The vapor axial deposition apparatus as set forth in claim 8, wherein the rod cap has a hemispherical shape.

12. The vapor axial deposition apparatus as set forth in claim 8, wherein the rod cap has a truncated conical shape.

13. The vapor axial deposition apparatus as set forth in claim 8, wherein said narrowed end is disposed toward a portion of said rod cap axially aligned with said starting rod.

14. A vapor axial deposition apparatus for manufacturing an optical fiber preform, comprising:
a starting rod configured for axial rotation while positioned vertically, said starting rod having a lower portion; and
a rod cap made of at least one of quartz and ceramic, said rod cap being fixed to a lower portion of the starting rod and serving as a rotary body having a narrowed end toward a portion of said rod cap axially aligned with said starting rod, said apparatus being usable with:
a first heater for growing a core on a central portion of the rod cap by shooting a flame toward said central portion; and
a second heater for growing a cladding on an outer circumference of the rod cap by shooting a flame toward said outer circumference.

15. The vapor axial deposition apparatus as set forth in claim 14, wherein the rod cap includes a base portion having a hemispherical shape, and a protruded portion protruding from the base portion and having a hemispherical shape.

16. The vapor axial deposition apparatus as set forth in claim 14, wherein the rod cap has a hemispherical shape having a depressed central portion.

17. The vapor axial deposition apparatus as set forth in claim 14, wherein the rod cap has a hemispherical shape.

18. The vapor axial deposition apparatus as set forth in claim 14, wherein the rod cap has a truncated conical shape.

19. The vapor axial deposition apparatus as set forth in claim 14, further comprising a chuck moving vertically and rotating, wherein the starting rod has an upper end fixed to the chuck.

20. The vapor axial deposition apparatus as set forth in claim 14, wherein said flame toward said central portion shoots upward and said flame toward said outer circumference shoots laterally.
